(19) United States
(12) Patent Application Publication
(10) Pub. No.: US 2005/0036569 A1
(43) Pub. Date: Feb. 17, 2005

(54) Perturbation and equalization method and system for multi-user detection

(76) Inventor: Chun Chian Lu, Taoyuan (TW)

Correspondence Address: Finnegan, Henderson, Farabow,;Garrett & Dunner, L.L.P., 1300 I Street, N.W., Washington, DC, 20005-3315, US

(21) Appl. No.: 10/639,144

(22) Filed: Aug. 11, 2003

(51) Int. Cl. H04L 27/06

(52) U.S. Cl. 375/316; 375/343

(57) ABSTRACT

A signal processing method comprises receiving a first signal for wireless communication, obtaining an approximate of a non-channel function in the first signal, separating the approximate of the non-channel function from the first signal to obtain a second signal that includes a time-varying channel function, and processing the second signal to obtain a user signal. Also disclosed is a system for carrying out the method.

### DESCRIPTION OF THE INVENTION

1. Field of the Invention

This invention pertains in general to signal processing methods and signal processing systems and, more particularly, to perturbation and equalization methods for multi-user detection in wireless communication systems.

2. Background of the Invention

Wireless communications usually operate according to a designated protocol within a designated frequency range or bandwidth. Due to the bandwidth limitations, one of the many challenges to the development of wireless communication systems and methods lies in increasing the number of users allowed, maintaining the data rate available to each user, and improving the quality of wireless communication, all being accomplished without increasing the bandwidth required.

As an example, a code division multiple access (CDMA) network seeks to provide communication channels for two or more users using the same bandwidth. To provide multi-user access, signal receivers must separate out signals of different users. To accomplish this goal, receivers use two designs, a single-user detector and a multi-user detector. A single-user detector operates to estimate and obtain the signal of a particular user, usually by removing signals of other users or treating those signals as noise. However, due to imperfect correlation properties of spreading codes, a single-user detector, such as a rake receiver, is sensitive to multi-path and near-far problems. In particular, interference in a band-limited CDMA system makes conventional single-user detection more error prone.

In contrast with a single-user detector, a multi-user detector may avoid interference problems by estimating signals of different users with the same detector. However, to effectively process the signals of different users, a multi-user detector has a much more complex design and consumes many more processing resources than a single-user detector.

Signals for wireless communications may have different components and/or different code schemes for various purposes. However, those components or code schemes may create other problems for user signal detection. For example, in a band-limited communication system, such as a CDMA system, pulse shaping (“PS”) or low-pass filtering of a digital signal is necessary to reduce leakage to foreign bands. FIG. 1 is a graph showing an exemplary PS distortion to a spreading code due to a pulse shaping function. Pulse shaping, however, often introduces signal leakage in time domain and results in the inter-chip interference (“ICI”) or inter-symbol interference (“ISI”), which degrades user signal detection. An equalization scheme may apply to reduce the degradation in the detection. For example, an equalization scheme has been discussed in J. G. Proakis, “Digital Communications” (2d ed., 1989).

In addition to ICI and ISI, interference in a CDMA system due to multiple users and multi-path fading and problems with synchronization further degrades the detection. Numerous attempts have been made to solve the problems, which have been discussed, for example, in S. Verdu, “Minimum probability of error for asynchronous Gaussian multiple access channels, “IEEE Trans. Information Theory, Vol. IT-32, no. 1, pp. 85-96, January 1986, M. Honig, U. Madhow, and S. Verdu, “Blind adaptive detection,” IEEE Trans. Information Theory, Vol. 41, no. 4, pp. 944-960, July 1995, and H. Liu and K. Li, “A decorrelating rake receiver for CDMA communication over frequency-selective fading channels,” IEEE Trans. On Communications, Vol. 47, pp. 1036-1045, July 1999. Complexity remains the bottleneck inhibiting the improvement of communication systems to solve problems of a multi-user system.

To solve multi-user detection (“MUD”) problems in single-path and multi-path environments involving ISI and multi-access interference (“MAI”), perturbation methods have been applied recently to effectively relieve near-far problems in asynchronous CDMA systems. Examples of perturbation methods have been disclosed in C. C. Lu, “Perturbation principle of multi-user detection,” The 3rd IEEE International Conference on Mobile and Wireless Communications Networks, Recife, Brazil, pp. 103-110, August 2001 and C. C. Lu, “Perturbation method of interference cancellation in multi-path CDMA systems,” Proceedings of IEEE 7th Symposium on Spread Spectrum Techniques and Applications, Prague, pp. 278-282, September 2002. For the purpose of illustration, we may disregard PS problems for their simplicity and assume user signals have a few discrete multi-path images.

In addition to solving MUD problems, many approaches have been developed to correct errors caused by multi-user interference. Under one of the approaches, conventional CDMA receivers use error correction codes, including convolution codes and turbo codes. This conventional approach has several drawbacks. First, signal capacity is reduced by at least ½ due to the use of error-correction codes. Second, signal processing, such as processing of turbo codes, can be resources consuming. Third, upper limits exist as to correcting errors from rake receivers, as discussed in L. T. Smith, G. J. M. Smit, P. J. M. Havinga, J. L. Hurink, and H. Broersma, “Influences of rake receivers/turbo decoder parameters on energy consumption and quality,” Proceedings of 2002 International Conference on 3rd Generation Wireless and Beyond, San Francisco, May 2002.

Although other approaches to multi-user detection exist, such as utilizing an optimum multi-user detector, these approaches can be too complex to realize. An optimum multi-user detector has been disclosed in S. Verdu, “Minimum probability of error for asynchronous Gaussian multiple access channels” (listed above). Although sub-optimum detection techniques are available, those techniques can also be difficult to realize. Examples of those techniques include equalizers based on zero forcing (de-correlating) or minimum mean square error. Those equalizers have been disclosed, for example, in A. Klein, G. K. Kaleh, and P. W. Baier, “Zero forcing and minimum mean-square-error-equalization for multi-user detection in code-division multiple-access channels,” IEEE Trans. Vehicular Tech. vol. 45, no. 2, pp. 276-287, May, 1996.

In particular, to achieve effective equalization under the sub-optimum detection techniques, long blocks of data are used to obtain large Toeplitz matrices, which are complex functions of the channels and signatures (including PS) of all users. These matrices relate the received signal to the transmitted blocks of bits for many users. Due to the complexity of the transmitted bits and the size of the matrices to be processed or inverted, implementations of this approach remain very difficult.

Another approach to correct errors caused by multi-user interference involves multiple stage interference cancellation, which has been discussed in D. Divsalar, M. K. Simon and D. Raphaeli, “Parallel interference cancellation for CDMA,” IEEE trans Commun., vol. 46, no. 2, pp. 258-268, February 1998, and Q. Sun and D. Cox, “Effect of channel estimation error on a new pipelined multi-stage PIC detector for CDMA,” Proceedings of IEEE 7th Int. Symposium on Spread Spectrum Techniques and Applications, Prague, Czech Republic, pp. 628-632, September 2002. In calculating the bit data and the amplitude of one user, the interference caused by other users, which is based on the interference in the previous stage, is subtracted from the received signal. However, this process also requires significant computations.

Other than the approaches noted above, another approach to correct errors caused by the multi-user interference uses a linear predictive equalizer, which requires no knowledge of the other user's signature and signal delay. In other words, this approach completely ignores MAI. However, due to an interference whitening requirement and saturation effects, this approach suffers from slow convergence and inferior performance. Therefore, this approach can easily break down in fast fading channels. As an example, the interference-whitening requirement under this approach has been discussed in M. Honig et al., “Blind adaptive detection” and H. Liu et al., “A decorrelating rake receiver for CDMA communication over frequency-selective fading channels” (listed above).

### SUMMARY OF THE INVENTION

In accordance with the invention, there is provided a signal processing method that includes receiving a first signal for wireless communication, obtaining an approximate function of pulse shaping in the first signal, separating the approximate function of pulse shaping from the first signal to obtain a second signal, and processing the second signal to obtain a user signal.

Also in accordance with the invention, there is provided a signal processing method that includes receiving a first signal for wireless communication, obtaining an approximate of a non-channel function in the first signal, separating the approximate of the non-channel function from the first signal to obtain a second signal that includes a time-varying channel function, and processing the second signal to obtain a user signal.

Still in accordance with the present invention, there is provided a signal processing system that includes a receiver for receiving a first signal for wireless communication, a tracking device for obtaining an amplitude estimate and a symbol delay for a user, an approximating device for providing an approximate of a non-channel function in the first signal, and a signal-separating device for separating the approximate of the non-channel function from the first signal to obtain a second signal that includes a time-varying channel function.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and, together with the description, serve to explain the principles of the invention.

FIG. 1 is a graph showing a PS distortion to a spreading code due to pulse shaping;

FIG. 2 is a graph showing the results of applying direct perturbation MUD (multi-user detection), consistent with one embodiment of the present invention;

FIGS. 3 and 4 are graphs showing the results of applying perturbation MUD with blind equalization, consistent with one embodiment of the present invention;

FIG. 5 is a functional block diagram showing the processing in a CDMA perturbation detector, consistent with one embodiment of the present invention; and

FIG. 6 is a flow chart showing the steps of a CDMA detection, consistent with one embodiment of the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

This invention provides perturbation and equalization methods for multi-user detection in wireless communication systems. In one embodiment, the invention uses an equalization technique to separate the approximately known artificial distortion, non-channel function, or, in particular, pulse shaping (PS) function from the unknown, time-varying channel functions, thereby drastically reducing the dimension to be processed and allowing computation by perturbation theory. Furthermore, applying a higher order perturbation under this approach improves the approximation process. As a result, this approach also solves MUD problems without having to process or invert large matrices or completely ignoring MAI (multi-access interference). Additionally, the method may reduce the effects of PS, ISI (inter-symbol interference), and MAI of asynchronous CDMA in multi-path environments.

As noted above, signals for wireless communication may have different components and/or different code schemes for various purposes. Although the pulse shaping or the low-pass filtering of a signal reduces leakage, it also results in ICI (inter-chip interference) or ISI, degrading user signal detection. In contrast with the discrete multi-path translation in time domain, PS is a linear and continuous transformation of the square wave signal with continuous delay, resulting in an infinite set of images, which is greatly different from the discrete signals of multi-user and multi-path. Mathematically, PS or filtering creates functions in Hilbert space of infinite dimensions, thereby producing more basic functions or more orthogonal codes than transmitted. The approximate dimension of the new space is N times samples per chip (“spc”), where N is the dimension of the original spreading codes.

For the known response function of pulse shaping, the discrete time square root raised cosine (required by wideband CDMA) is

$$S ( n ) = \frac{sin ( π t ( 1 - α ) ) + 4 α t cos ( π t ( 1 + α ) )}{π t ( 1 - {( 4 α t )}^{2} )} ,$$

wherein
α=0.22
   t=(n+δ*spc*TAP/2)spc
n=0 . . . spc*TAP
δ=0.00001
TAP=8
spc=4

The PS response function is normalized to
h(n)=S(n)/no
no\sqrt{ΣS(n)²}

The received signal after PS and channel distortion can be written as

$$r ( t ) = {\sum }_{n} {\sum }_{i = l}^{M} {\sum }_{j = l}^{p} {a}_{ijn} {ψ}_{i} ( jn ) \qquad Equation ( 1 )$$

wherein
M=number of users,
T=symbol period,
P=number of paths,
n=symbol number.
aᵢⱼₙ=time-varying amplitude of symbol n of user i, path j, including data bit,
ψᵢ(jn)=pulse shaped spreading code of user i in nth symbol, j th path.

To extract codes from the received signal, ψᵢ (jn) is decomposed into two parts.
ψᵢ(jn)=ψᵢ(t−τᵢⱼ−nT)+Δᵢ(jn)

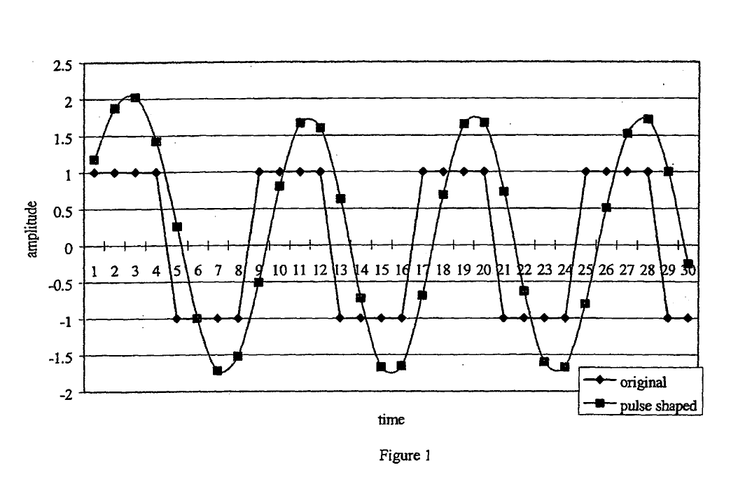

The first term is the original spreading code of the nth symbol of ith user at delay τᵢⱼ. τᵢⱼ is the time delay of path j of ψᵢ, which is less than T and to be obtained from delay tracking, Δᵢ(jn) is the small fixed PS distortion to the spreading code due to the pulse shaping, as shown in FIG. 1. With this definition, equation (1) can be written in the form:

$${r}^{′} ( t ) = r ( t ) - {\sum }_{n} {\sum }_{i = 1}^{M} {\sum }_{j} {a}_{ijn} {Δ}_{i} ( jn ) \\ = {\sum }_{n} {\sum }_{i = 1}^{M} {\sum }_{j} {a}_{ijn} {ψ}_{i} ( t - {τ}_{ij} - nT ) \qquad Equation ( 2 )$$

With the PS function distortion subtracted from received signal r(t), r′(t) has no PS effects and hence equation (2) becomes a finite mathematical (non-Hilbert space) problem. Furthermore, instead of a pulse-shaped code, the original binary code is used for all correlation, effectively reducing the computation needed. Obviously, this separation method also applies to other known linear filtering or PS if Δᵢ(jn) is relatively small.

Effective multi-user detection is accomplished by finding the best timing and amplitude for every user's symbol in the system so that r′(t) is equal to a linear combination of user codes. Perturbation methods may apply to accomplish this goal, but aᵢⱼₙ appearing on the right hand side of equation (2) above is unknown. An approximation technique may apply to approximate aᵢⱼₙ.

When we apply match filtering on equation (1) with ψⱼ(τⱼₖ), we will get a single peak at τⱼₖ, and that peak gives the single-user detection, including the delay and amplitude:

$${a}_{ijn} \approx {c}_{ijn} = ( {ψ}_{i} ( {τ}_{ij} + nT ) , r ) / {N}_{ijn} = {r}_{ijn} / {N}_{ijn} \\ {r}_{ijn} = ( {ψ}_{i} ( {τ}_{ij} + nT ) , r ) = {\int }_{0}^{T} {ψ}_{i} ( t - {τ}_{ij} - nT ) r ( t ) ⅆ t \\ {N}_{ijn} = {ψ}_{i} ( {τ}_{ij} + nT ) , {ψ}_{i} ( {τ}_{ij} + nT ) ) \qquad Equation ( 3 )$$

, wherein (x, y) represents a correlation. This is a zero order approximation.

To obtain a better amplitude aᵢⱼₙ when taking the interference into account, we need to look at the shortened time domain of only three symbols in one embodiment, because every symbol of each user will overlap and interfere with two or three symbols of other users. Therefore, the series in equation (2) is shortened to n=−1, 0, and 1. We can solve the amplitudes in the middle symbol (n=0) of every user and slide this 3-symbol window one symbol at a time. The approximation is then corrected according to the perturbation theory.
aᵢⱼₙ=cᵢⱼₙ+c′ᵢⱼₙ

Substituting this aᵢⱼₙ in equation (2) and applying the zero order approximation again result in a single-user perturbation correction:

$${c}_{jk0}^{′} = {r}_{jk0}^{′} - {\sum }_{i = 1}^{M} {\sum }_{l} {\sum }_{n = - 1}^{n = 1} {c}_{iln} {H}_{ji} ( n , k , 1 ) \\ {r}_{ijn}^{′} = ( {ψ}_{i} ( {τ}_{ij} + nT ) , {r}^{′} ) \qquad Equation ( 4 )$$

The correlation matrix is given by
Hⱼᵢ(n,k,l)=(ψⱼ(τⱼₖ), ψᵢ(τᵢₗ+nT)/Nⱼₖ₀

In multiple rate CDMA, the interference window may be extended to N-symbol. The n in equation (4) starts from —N/2 to N/2.

Theoretically, aᵢₗₙ from equation (4) is better than C_{iln,} and the immediate feedback can further improve the correction.

In general, a CDMA system requires that a channel must be quasi-static, which means that the channel remains unchanged within a few symbols. Therefore, a signal can be divided into frames, each of which consists of a number of symbols, such as ten symbols. And the code and code delay remain almost constant during each frame.

Perturbation methods leave the more extensive (larger than 3 symbols) interference to the higher order perturbation. We use the same routines and the same correlation matrices for iterations in the same frame. The cᵢₗₙ in equation (4) is replaced by the new aᵢₗₙ whenever the new aᵢₗₙ becomes available.

r′(t) is obtained by decision feedback. As a result, we use the following aᵢⱼₙ for the first summation in equation (2).
aᵢⱼₙ≈bᵢ[n]rᵢⱼ

bᵢ[n] is the nth bit of the ith user, and rᵢⱼ is the maximum ratio-combining (“MRC”) coefficient of path j of the ith user's code, coming from the channel estimation. In a blind equalizer, bᵢ[n] is the best estimate obtained from the MRC rake receiver initially (using cᵢⱼₙ), and afterward from the last order of perturbation. If there is a training sequence for bᵢ[n] then the equalizer obtains the optimum channel estimation rᵢⱼ for use in the data part.

We can compute a better r′(t) after a few orders of perturbation, and go through a new round of calculation to obtain a better-approximated aᵢⱼₙ.

In summary, the present invention uses a decision feedback equalization (“DFE”) to separate the approximately known function of pulse shaping from the unknown function of the time-varying channel and the final solution in perturbation theory. The approximation and hence the solution get better as higher order perturbation is applied. The approach solves the MUD problems without inverting large matrices or ignoring MAI.

In support of the present invention, we conducted some simulations, wherein a bit error rate (“BER”) is calculated based on equation (3) for a single-user detection and equation (4) for a perturbation projection. In particular, we apply the maximum ratio combining (“MRC”) for multi-path to the uncorrected and (interference) corrected amplitudes to compare the BER for the rake and perturbation projection. The error correction capacities of perturbation methods are shown as functions of delay-spread, multi-path fading.

As an illustrative example, the results of calculating using Walsh function spreading codes are presented. We make maximum use of the spectrum by assigning M users to M-dimensional (chip) Walsh codes in a single-cell environment, using 16 for M in all calculations. The relative delay of each code is random, and the delay-spread distribution of the users τᵢₗ is assumed to have independent, identical distribution (iid) in the interval [0, dmax], wherein dmax is the maximum delay spread. Here the unit of delay is sample. We have 4 spc (samples per chip) according to the pulse shaping in all calculations, providing a distribution model for an asynchronous system.

Near-far mix and multi-path amplitudes are also simulated by iid distribution (in [0, 1]). The absolute amplitude of a user stays constant within a frame (assuming 10 bits) but changes from frame to frame. The multi-paths have the same average power, but their symbols are not synchronous and hence interfere with each other. Therefore, a model is provided for near-far and multi-path problems.

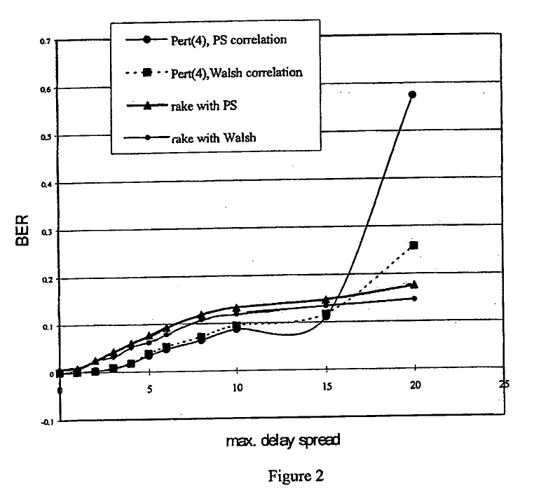

FIG. 2 shows how the perturbation MUD works without equalization, solving equation (1) above directly. Referring to FIG. 2, Pert(4) means a 4th order perturbation. As illustrated in FIG. 2, four different curves are provided to show BER (bit error rate) results under four different approaches, including two MUDs, i.e., a 4th order perturbation with PS correlation and a 4th order perturbation with Walsh correlation, and two single-user detectors (“SUDs”), i.e., a rake approach with PS and a rake approach with Walsh codes. This direct perturbation method works better than a rake approach at smaller delay spreads (less than 4 chips). But it breaks down at larger delay spreads, because the PS-caused continuous interference is not properly corrected in this direct perturbation method. To correct the interference, equalization is applied before perturbation, namely solving equation (2) instead of equation (1).

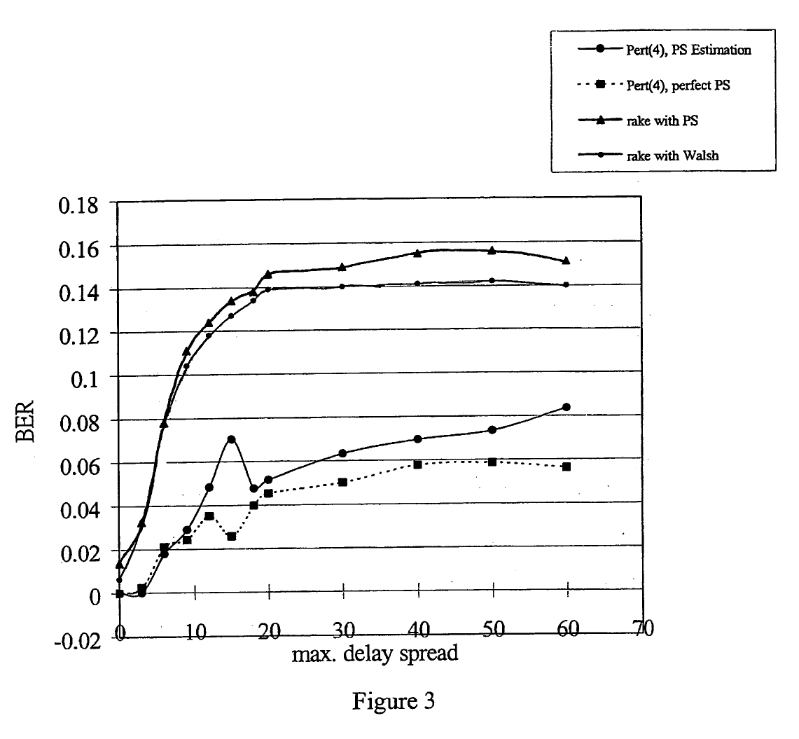

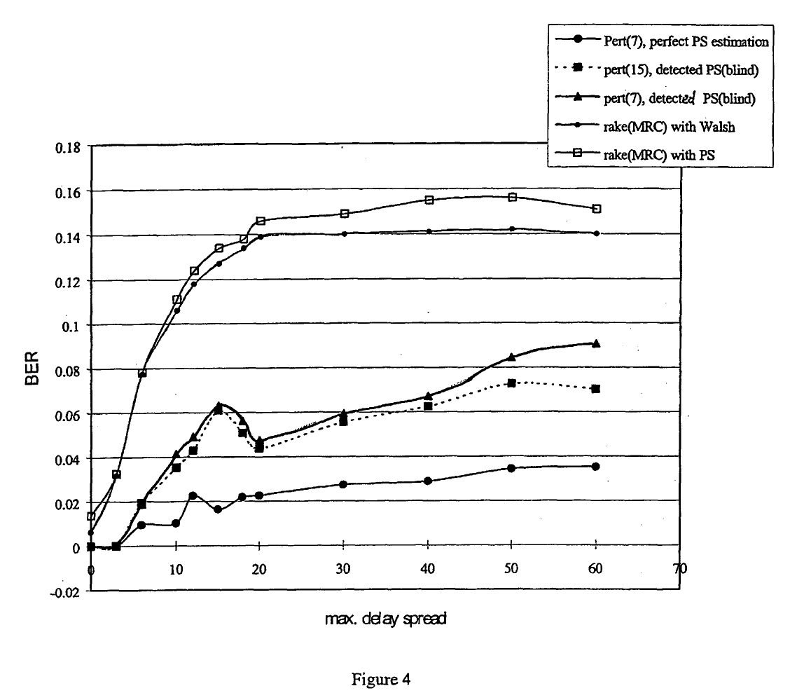

FIGS. 3 and 4 show how the perturbation MUD with blind or non-blind equalization performs in comparison with other methods. Referring to FIG. 3,
means 4th order perturbation. As illustrated in FIG. 3, four different curves are provided to show the BER results under four different approaches, including a 4th order perturbation with PS estimation, a 4th order perturbation with perfect PS, a rake (SUD) approach with PS, and a rake (SUD) approach with Walsh codes. In FIG. 4, five different curves are provided to show the BER results under five different approaches, including a 7th order perturbation with perfect PS estimation, a 15th order perturbation with detected PS and blind equalization, a 7th order perturbation with detected PS and blind equalization, a rake approach with Walsh codes and MRC, and a rake approach with PS and MRC. Perfect channel estimation is used through all calculations, including MRC rake and pulse shaping estimations. Pulse shaping of the whole frame is obtained from the perfect channel estimation multiplied by the data bits. If the data bits for the perfect PS are the transmitted bit streams, a non-blind equalizer is presented. If the data bits for the PS estimation come from rake receiver initially and from MUD afterward, a blind equalizer is presented.

Although some degradations in the blind equalizer exist due to the data estimation error, the results with blind equalization show a substantial improvement over that of FIG. 2. In addition, FIGS. 3 and 4 also show that direct correlation with Walsh codes works better than correlation with pulse shaped waveforms.

Using equation (2) instead of equation (1) enables using direct binary codes for all correlation, rather than using pulse-shaped codes for correlation, thereby simplifying the computation of correlation. Correlation matrices are then computed directly from codes and their delays.

The correlation matrix Hⱼᵢ(n,k,l) going through p paths has M²p² elements, with n=−1, 0, and 1 for a frame and i and j going through all users and their respective paths l and k. By using orthogonal codes, such as Walsh codes multiplied by scrambling codes of the same length, great saving in computing the correlation matrices is obtained by using an interpolation. We can compute every element at a fractional chip offset by a linear interpolation from the nearest elements of integer chip steps. Therefore, we have to compute the correlation matrix at integer chip offsets for all codes only once. The amount of computing a matrix is now proportional to M²p². Also, the amount of computing interference on the right hand side of equation (4) is proportional to M²p². Accordingly, the total amount of computation is proportional to M²p², instead of p²2^{M} in the maximum likelihood MUD.

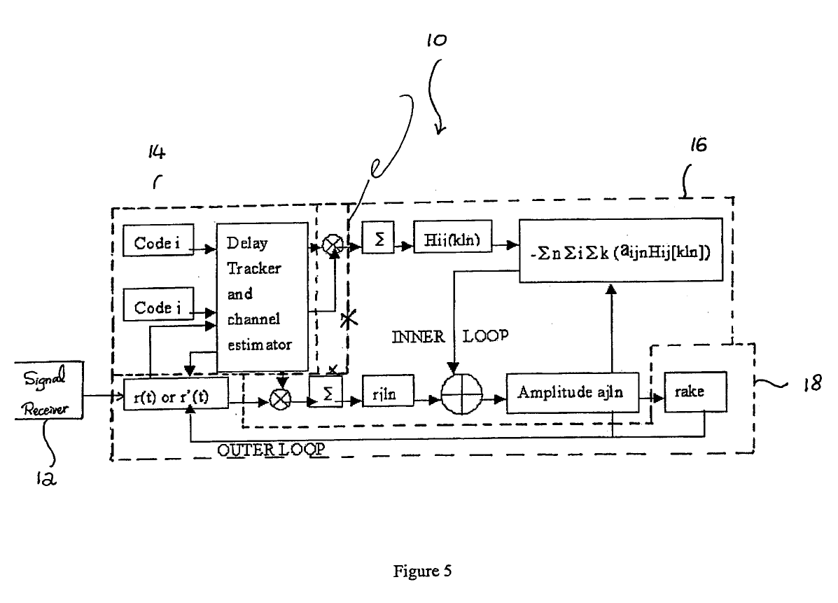

FIG. 5 describes the processing in a CDMA perturbation detector in one embodiment. As an example, a CDMA detection starts with the delay tracking of the received signal r(t), determining the time delay τᵢₗ of the code of every user in a symbol period. Next, the correlation matrices are computed with all codes and their respective delays. The new amplitude aᵢₗₙ is the linear combination of the previously calculated amplitudes for the symbols of every user present, multiplied by the correlation matrices, as shown by equation 4 above.

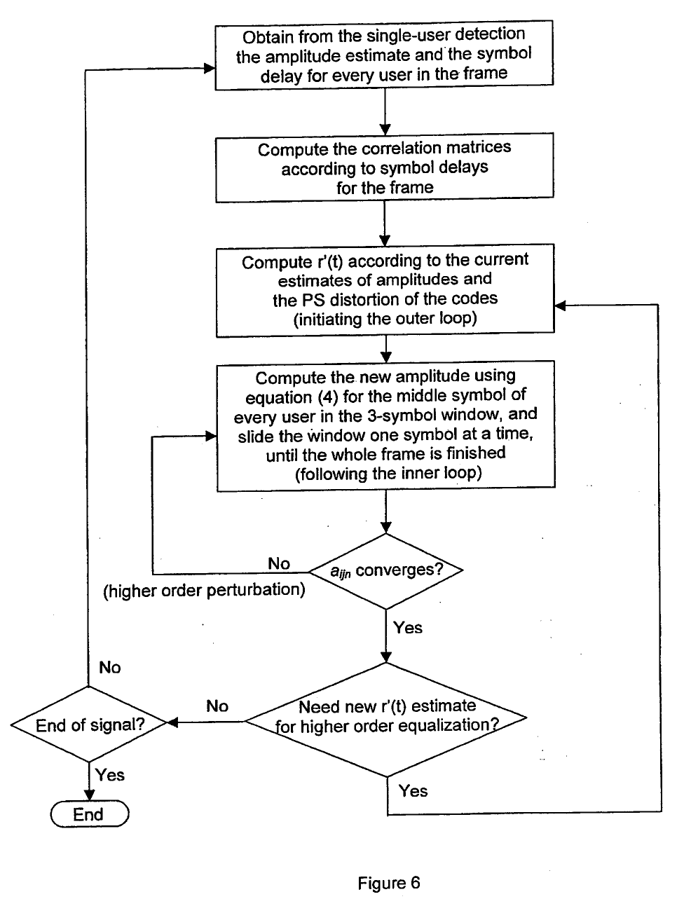

In particular, referring to the functional block diagram of FIG. 5 and the flow chart of FIG. 6, CDMA detection in one embodiment includes the following steps:
a) obtain from the single-user detection the amplitude estimate and the symbol delay for every user in the frame;
b) compute the correlation matrices according to symbol delays for the frame;
c) compute r′(t) according to the current estimates of amplitudes and the PS distortion of the codes, thus initiating the outer loop;
d) compute the new amplitude using equation (4) for the middle symbol of every user in the 3-symbol window, and slide the window one symbol at a time, until the whole frame is finished, following the inner loop;
e) return to the beginning of the frame and step d) for higher order perturbation, until aᵢⱼₙ converges; and
f) return to step c) for a new r′(t) estimate for higher order equalization, following the outer loop, or alternatively, go to step a) for a new frame and proceed with the same procedure until the end of signal processing.

Referring to FIG. 5, the present invention provides a signal processing system 10 in one embodiment. Signal processing system 10 includes a signal receiver 12 for receiving a first signal r(t) for wireless communication and a tracking device 14 for obtaining an amplitude estimate and a symbol delay for every user. Signal processing system 10 also includes an approximating device 16 for providing an approximate of a non-channel function in the first signal and a signal-separating device 18 for separating the approximate of the non-channel function from the first signal r(t) to obtain a second signal r′(t) that includes a time-varying channel function. As shown by the inner and outer loops in FIG. 5, signal-separating device 18 may apply one or more equalizations and/or apply one or more orders of perturbation to adjust the approximate of the non-channel function.

The amplitudes aᵢⱼₙ obtained in each and final steps become the coefficients for MRC and, hence, give better channel estimation than a conventional rake receiver.

As discussed above, the present invention provides a method of calculating multi-user interference according to perturbation and equalization. In one embodiment, using a higher order perturbation accomplishes better results than a conventional rake receiver. Furthermore, although the invention is illustrated with one embodiment using a pulse shaping function, the present invention can be generalized and applied to other communication signals with any linear or nonlinear continuous transformation, including, but not limited to, other pulse shaping functions and (low-pass) filtering, or other transformations that conserve the gross property of the original waveforms.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A signal processing method comprising:
receiving a first signal for wireless communication;
obtaining an approximate function of pulse shaping in the first signal;
separating the approximate function of pulse shaping from the first signal to obtain a second signal; and
processing the second signal to obtain a user signal.

2. The method of claim 1, further comprising:
conducting a single-user detection; and
obtaining an amplitude estimate and a symbol delay for a user in a frame.

3. The method of claim 1, wherein the second signal has insignificant or no pulse shaping effects.

4. The method of claim 1, wherein separating the approximate function of pulse shaping from the first signal comprises applying an equalization.

5. The method of claim 1, wherein separating the approximate function of pulse shaping from the first signal comprises applying a decision feedback equalization.

6. The method of claim 1, wherein separating the approximate function of pulse shaping from the first signal comprises applying at least one order of perturbation to adjust the approximate function of pulse shaping.

7. The method of claim 1, wherein separating the approximate function of pulse shaping from the first signal comprises:
applying at least two equalizations; and
repetitively applying at least one order of perturbation to adjust the approximate function of pulse shaping.

8. The method of claim 1, wherein separating the approximate function of pulse shaping from the first signal comprises separating an approximately known function of pulse shaping from a received function of a time-varying channel function.

9. A signal processing method comprising:
receiving a first signal for wireless communication;
obtaining an approximate of a non-channel function in the first signal;
separating the approximate of the non-channel function from the first signal to obtain a second signal that includes a time-varying channel function; and
processing the second signal to obtain a user signal.

10. The method of claim 9, wherein the non-channel function comprises a function selected from a linear and continuous transformation function, a pulse-shaping function, and a low-pass filtering.

11. The method of claim 9, further comprising:
conducting a single-user detection; and
obtaining an amplitude estimate and a symbol delay for a user in a frame to obtain the approximate of the non-channel function.

12. The method of claim 9, wherein the second signal has insignificant or no non-channel functions.

13. The method of claim 9, wherein separating the approximate of the non-channel function from the first signal comprises applying an equalization.

14. The method of claim 9, wherein separating the approximate of the non-channel function from the first signal comprises applying a decision feedback equalization.

15. The method of claim 9, wherein separating the approximate of the non-channel function from the first signal comprises applying at least one order of perturbation to adjust the approximate of the non-channel function.

16. The method of claim 9, wherein separating the approximate of the non-channel function from the first signal comprises separating an approximately known non-channel function from a received function of a time-varying channel function.

17. The method of claim 9, wherein separating the approximate of the non-channel function from the first signal comprises:
applying at least two equalizations; and
repetitively applying at least one order of perturbation to adjust the approximate of the non-channel function.

18. A signal processing system, comprising:
a receiver for receiving a first signal for wireless communication;
a tracking device for obtaining an amplitude estimate and a symbol delay for a user;
an approximating device for providing an approximate of a non-channel function in the first signal; and
a signal-separating device for separating the approximate of the non-channel function from the first signal to obtain a second signal that includes a time-varying channel function.

19. The method of claim 18, wherein the non-channel function comprises a function selected from a linear and continuous transformation function, a pulse-shaping function, and a low-pass filtering.

20. The method of claim 18, wherein separating the approximate of non-channel function from the first signal comprises at least one of the following process:
applying at least one equalization; and
applying at least one order of perturbation to adjust the approximate of the non-channel function.
